(19) United States
(12) Patent Application Publication
(10) Pub. No.: US 2009/0176077 A1
(43) Pub. Date: Jul. 9, 2009

(54) OPTICAL LAYERED BODY

(75) Inventors: Tomoyuki Horio, Tokyo (JP); Kenji Ueno, Tokyo (JP)

Correspondence Address: CONNOLLY BOVE LODGE & HUTZ LLP, 1875 EYE STREET, N.W., SUITE 1100, WASHINGTON, DC, 20006, US

(73) Assignee: Dai Nippon Printing Co., Ltd., Tokyo (JP)

(21) Appl. No.: 12/295,061

(22) PCT Filed: Mar. 30, 2007
(86) PCT No.: PCT/JP2007/057187

§ 371 Date: Nov. 12, 2008

(30) Foreign Application Priority Data
Mar. 31, 2006 (JP) 2006-100951

(51) Int. Cl. B32B 7/02; B32B 9/04; B32B 27/00; B32B 27/36; B32B 27/34; B32B 27/06; B32B 27/40; B05D 5/06

(52) U.S. Cl. 428/217; 428/704; 428/500; 428/480; 428/474.4; 428/473.5; 428/412; 428/423.1; 427/164

(57) ABSTRACT

It is an object of the present invention to provide an optical layered body which efficiently suppresses or prevents appearance of interference fringes and exhibits high surface hardness. a An optical layered body comprising: a at least (1) a hard coat layer A adjacent to a light transmitting substrate and (2) a hard coat layer B, formed on the substrate, a wherein there is substantially no interface between the substrate and the hard coat layer A.

### TECHNICAL FIELD

The present invention relates to a novel optical layered body.

### BACKGROUND ART

In an image display device such as a cathode-ray tube display device (CRT), a plasma display (PDP), an organic or inorganic electroluminescent display (ELD), a field emission display (FED), or a liquid crystal display (LCD), it is required to prevent contrast decrease and visibility deterioration due to reflection of outside light or image reflection. Therefore, it is common to form an antireflection layered body in the outermost face of an image display device in order to lessen the image reflection or reflectivity based on the principle of light scattering or the principle of optical interference.

In the antireflection layered body, a hard coat layer is formed on a transparent material or further other layers are formed on a hard coat layer to provide desired functions (e.g., an antistatic property, antifouling property, antireflection, and the like).

However, in the case where a hard coat layer or the like is formed on a transparent substrate, the reflected light of the transparent substrate surface and the reflected light of the hard coat layer surface are interfered and uneven patterns so-called interference fringes appear attributed to unevenness of the thickness, which results in causing a problem such that appearance is deteriorated.

In order to solve the problem, from an optical viewpoint, there is a method of making the thickness of a hard coat layer extremely thick as several um or thicker or a method of making the thickness thin to about 100 nm. However, the former is insufficient for practical application because of crack formation as well as high cost or the like. The latter also has a problem that it is impossible to provide sufficient surface hardness.

Patent Document 1: Japanese Kokai Publication 2005-107005

### DISCLOSURE OF THE INVENTION

### Problems to be Solved by the Invention

Accordingly, it is a main object of the present invention is to provide an optical layered body which efficiently suppresses or prevents appearance of interference fringes and exhibits high surface hardness.

### Means for Solving the Problems

In view of the problems of the conventional technique, the present inventors of the present invention have made earnest investigations and have found that the above-mentioned object can be accomplished by employing a specified layer configuration and the finding have led to completion of the present invention.

The present invention relates to an optical layered body comprising: at least (1) a hard coat layer A adjacent to a light transmitting substrate and (2) a hard coat layer B, formed on the substrate, wherein there is substantially no interface between the substrate and the hard coat layer A.

Preferably, the hard coat layer B is formed from a composition B containing a urethane (meth)acrylate compound having 6 or higher functional groups.

Preferably, the urethane (meth)acrylate compound has a weight average molecular weight of 1000 to 50000.

Preferably, the hard coat layer A is formed from a composition A containing a compound A having a weight average molecular weight of 200 or higher and 3 or higher functional groups.

Preferably, the compound A is at least one of a (meth)acrylate compound and a urethane (meth)acrylate compound.

Preferably, the composition A contains a solvent having penetrability or solubility for the substrate.

Preferably, the optical layered body has substantially no interference fringe.

Preferably, the hard coat layer A and the hard coat layer B have a pencil hardness of 4 H or higher.

Preferably, the hard coat layer A has a Vicker's hardness of 450 N/mm or higher and the hard coat layer B has a Vicker's hardness of 550 N/mm or higher.

Preferably, the optical layered body further comprises an antistatic layer, an antiglare layer, a low refractive index layer, an antifouling layer, or two or more of these layers 1) between the hard coat layer A and the hard coat layer B; 2) on the hard coat layer B; or 3) under the hard coat layer A.

Preferably, the optical layered body is used as an antireflection layered body.

Further, the present invention relates to a method for producing an optical layered body comprising the steps of: (1) forming a hard coat layer A by applying a composition A to a light transmitting substrate; (2) forming a hard coat layer B by applying a composition B to the hard coat layer A, wherein the composition A contains a compound A having a weight average molecular weight of 200 or higher and 3 or higher functional groups and a solvent having penetrability and solubility for the light transmitting substrate, and the composition B contains a urethane (meth)acrylate compound having 6 or higher functional groups.

### Effects of the Invention

An optical laminated body of the present invention provides a state of absence of any substantial interface between a substrate and a hard coat layer A by forming at least two specified hard coat layers. Accordingly, occurrence of interference fringes is suppressed or prevented and high surface hardness can be exhibited. Further, the layered body of the present invention can efficiently suppress curling at the time of processing owing to the above-mentioned configuration.

The optical layered body of the present invention is preferably usable as a hard coat layered body for an antireflection layered body (including application as an antiglare layered body). Further, the optical layered body of the present invention is utilized for a transmission type display device. In particular, it is usable for a display such as a television, a computer, a word processor, and the like and it is furthermore preferably usable for the surface of a display such as a CRT, a liquid crystal panel and the like.

### BRIEF DESCRIPTIONS OF THE DRAWINGS

FIG. 1 is a drawing showing layered configuration (cross section) of an optical layered body produced in Example within the scope of the present invention.

### BEST MODE FOR CARRYING OUT THE INVENTION

An optical layered body of the present invention is a layered body comprising at least (1) a hard coat layer A adjacent to a light transmitting substrate and (2) a hard coat layer B, formed on the substrate and is characterized in that there is substantially no interface between the substrate and the hard coat layer A.

In this description, acrylate and methacrylate are collectively referred to as (meth)acrylate in some cases.

Hereinafter, the respective layers of the optical layered body of the present invention will be described. In the present invention, curable resin precursors such as monomers, oligomers, prepolymers and the like may be collectively referred to as “resin” unless otherwise specified.

### Light Transmitting Substrate

A light transmitting substrate is preferably those provided with smoothness, heat resistance and excellent in mechanical strength.

Specific examples of materials for the light transmitting substrate include thermoplastic resins such as polyester (polyethylene terephthalate and polyethylene naphthalate), cellulose triacetate, cellulose diacetate, cellulose acetate butyrate, polyester, polyamide, polyimide, polyether sulfone, polysulfone, polypropylene, polymethylpentene, poly(vinyl chloride), polyvinyl acetal, polyether ketone, poly(methyl methacrylate), polycarbonate or polyurethane, and preferably polyester (polyethylene terephthalate and polyethylene naphthalate) and cellulose triacetate, and particularly preferably cellulose triacetate.

Commercially available products may be used for these materials. For example, as polyester resin, trade name “A-4100” and “A-4300” produced by Toyobo Co., Ltd. are preferable. Further, as cellulose triacetate, trade name “TF80UL” and “FT TDY 80UL” produced by Fuji Photo Film Co., Ltd. are preferable.

In the light transmitting substrate, the thermoplastic resin is preferably used in the form of film-like bodies with good flexibility, however, plates of these thermoplastic resins are also usable in accordance with the application aspects for which curability is required and also plate-like bodies such as glass plates may be used.

In addition, as the light transmitting substrate, amorphous olefin polymer (Cyclo-Olefin-Polymer: COP) films having alicyclic structures can be exemplified. They are substrates of norbornene polymer, monocyclic olefin polymer, cyclic conjugated diene polymer, vinyl alicyclic hydrocarbon polymer, and the like, and examples thereof include Zeonex and Zeonoa (norbornene resin) produced by Zeon Corporation; Sumilite FS-1700 produced by Sumitomo Bakelite Co., Ltd.; Arton (modified norbornene resin) produced by JSR Corporation; Apel (cyclic olefin copolymer) produced by Mitsui Chemicals, Inc.; Topas (cyclic olefin copolymer) produced by Ticona; Optorez OZ-1000 series (alicyclic acrylic resin) produced by Hitachi Chemical Co., Ltd.; and the like

As substituting substrates of triacetyl cellulose, FV series (low birefringent refractive index, low optical elastic modulus film) produced by Asahi Kasei Corporation are also preferable.

The thickness of the light transmitting substrate is preferably 20 μm or more and 300 μm or less and more preferably 30 μm or more and 200 μm or less. In the case where the light transmitting substrate is a plate-like body, the thickness may exceed these thicknesses, which is 300 μm or more 5000 μm or less. The substrate may be previously subjected to physical treatment such as corona discharge treatment, oxidation treatment, and the like or may be coated with an anchor agent or a coating material called as a primer at the time of forming the hard coat layer or antistatic layer in order to improve the adhesiveness.

### Hard Coat Layer

A “hard coat layer” of the present invention means those having hardness of “H” or higher in a pensile hardness test standardized in JIS 5600-5-4(1999).

In the present invention, at least (1) a hard coat layer A adjacent to a substrate and (2) a hard coat layer B as an outermost surface layer are formed. The hard coat layer A suppresses or prevents occurrence of interference fringes. Further, the hard coat layer A can efficiently suppress curling of the layered body. Owing to the hard coat layer B, a prescribed hardness can be provided. Thus, owing to the layered configuration of two hard coat layers, the problems of interference fringes and hardness are solved at one effort.

The thickness of each hard coat layer can be suitably set in accordance with the desired properties, however, it is, in general, preferably 0.1 to 100 μm, and particularly preferably 0.8 to 20 μm.

The respective hard coat layers are not particularly limited if they have transparency. For example, one or more kinds of resins curing with ultraviolet ray or electron beam radiation (ionizing radiation-curable resins), solvent-drying resins, and thermosetting resins can be used. Conventionally known or commercially available resins may be used for these resins. In the present invention, ionizing radiation-curable resins are preferable to be used. Examples of the ionizing radiation-curable resins include polyester resins, polyether resins, acrylic resins, epoxy resins, urethane resins, spiroacetal resins, polybutadiene resins, polythiol-polyene resins, and the like. They may be used alone or two or more of them in combination.

The respective hard coat layers are formed using compositions containing raw material components (compositions for forming hard coat layers). More substantially, solutions or dispersions obtained by dissolving or dispersing raw material components and if necessary additives in solvents may be used as the compositions for forming a hard coat layer and coating films of the compositions are formed and cured to obtain the respective hard coat layers.

A preparation method of the above-mentioned compositions is sufficient if it can evenly mix the respective components and may be carried out according to conventionally known methods. For example, mixing may be carried out using a conventionally known apparatus such as a paint shaker, a bead mill, a kneader, a mixer.

A method for forming a coating film may be a conventionally known method. For example, the following various kind methods can be used: a spin coating method, a dipping method, a spraying method, a die coating method, a bar coating method, a roll coater method, a meniscus coater method, a flexo-printing method, a screen printing method, a bead coater method, and the like.

A method of curing the obtained coating films can be suitably selected in accordance with the contents of the above-mentioned compositions. For example, in the case of ultraviolet-curable resin, curing may be carried out by radiating ultraviolet rays to the coating films.

The compositions A or composition B to be used for forming each hard coat layer A or hard coat layer B may contain raw material components of the above-mentioned resins having transparency and can be suitably set in accordance with the types of resins. Examples are one or more compounds selected from monofunctional monomers such as ethyl (meth)acrylate, ethylhexyl (meth)acrylate, styrene, methylstyrene, N-vinylpyrrolidone, and the like; and polyfunctional monomers such as urethane (meth)acrylate, polyester (meth)acrylate, polymethylolpropane tri(meth)acrylate, hexanediol (meth)acrylate, polyethylene glycol di(meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, neopentyl glycol di(meth)acrylate, isocyanuric acid-modified di (or tri)acrylate, and the like.

In the present invention, particularly preferable among them is at least one of (meth) acrylate type compounds such ethyl (meth)acrylate, ethylhexyl (meth)acrylate, urethane (meth)acrylate, polyester (meth)acrylate, polymethylolpropane tri(meth)acrylate, hexanediol (meth)acrylate, polyethylene glycol di(meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and the like. That is, at least one of the acrylate compounds and/or the methacrylate compounds can be suitably used.

In the composition A or composition B, a solvent may be used based on the necessity. The solvent can be suitably selected from conventionally known solvents based on the types of raw material components to be used.

Examples of the solvent include alcohols such as methanol, ethanol, isopropyl alcohol, butanol, isobutyl alcohol, methyl glycol, methyl glycol acetate, methyl cellosolve, ethyl cellosolve, and butyl cellosolve; ketones such as acetone, methyl ethyl ketone, methyl isobutyl ketone, cyclohexanone, and diacetone alcohol; esters such as methyl formate, methyl acetate, ethyl acetate, ethyl lactate, and butyl acetate; nitrogen-containing compounds such as nitromethane, N-methylpyrrolidone, and N,N-dimethylformamide; ethers diisopropyl ether, tetrahydrofuran, dioxane, and dioxolane; halogenated hydrocarbons such as methylene chloride, chloroform, trichloroethane, and tetrachloroethane; and others such as dimethyl sulfoxide, propylene carbonate, and mixtures of two or more of them. Preferable solvents are at least one of methyl acetate, ethyl acetate, butyl acetate, methyl ethyl ketone, and the like.

In particular, as a solvent for the composition A, those having permeability to the light transmitting substrate to be used can be preferably used. For example, in the case of using a cellulose type resin as the light transmitting substrate, methyl ethyl ketone, methyl acetate, and ethyl acetate can be preferably used.

In the case a solvent is used for the composition A or the composition B, the use amount of the solvent can be suitably set in a range of 5 to 80% by weight as a solid content of each composition.

### (Hard Coat Layer A)

In particular, it is preferable to use a composition (mixture) containing a compound (compound A) having a weight average molecular weight of 200 or higher and three or higher functional groups for the composition A for forming the hard coat layer A. Use of such a compound A efficiently suppresses occurrence of interference fringes.

The weight average molecular weight is generally 200 or higher, preferably 250 or higher, more preferably 300 or higher, and even more preferably 350 or higher. The upper limit of the above-mentioned weight average molecular weight is not particularly limited, however it may be generally 40000 or lower. The number of the above-mentioned functional groups is generally 3 or higher, preferably 4 or higher, and even more preferably 5 or higher. The upper limit of the above-mentioned functional group is not particularly limited, however, it may be generally 15 or lower.

The compound A may be those having the above-mentioned weight average molecular weight and number of the functional groups, and as described, at least one of (meth)acrylate compounds and urethane (meth)acrylate compounds can be preferably used. For example, at least one of polyester (meth)acrylate, urethane acrylate and polyethylene glycol di (meth) acrylate, which have the above mentioned weight average molecular weight and number of the functional groups, can be preferably used.

Conventionally known or commercially available compounds can be used. The content ratio (solid content) of the compound A in the composition A is not particularly limited, however, it is generally 50 to 100% by weight (preferably 90 to 100% by weight). As components other than compound A, a polymerization initiator or additives described below and besides, a compound with a weight average molecular weight of less than 200 may be contained.

### (Hard Coat Layer B)

In particular, it is preferable to use a composition (mixture) containing a urethane (meth)acrylate compound having 6 or higher functional groups (preferably 6 or higher and 15 or less) as a raw material component. As the urethane (meth)acrylate compound, at least one of urethane (meth)acrylate compound having a weight average molecular weight of 1000 to 50000 (preferably 1500 to 40000) can be preferably used.

In the present invention, in addition to the urethane (meth)acrylate compound, (meth)acrylate compound having 3 or higher and 6 or lower functional groups (excluding the urethane (meth)acrylate compound) may be used in combination. As the (meth)acrylate compound, at least one of dipentaerythritol hexa(meth)acrylate, pentaerythritol tri(meth)acrylate, and the like can be preferably used.

The total content ratio (solid content) of the (meth)acrylate compound and urethane (meth)acrylate compound in the composition B is not particularly limited, however it is generally 10 to 100% by weight (preferably 20 to 100% by weight). As components other than these compounds, additives described below and besides, a compound having less than 3 functional groups may be contained.

The ratio of the (meth)acrylate compound and urethane (meth)acrylate compound is not particularly limited, however it is generally preferable that the ratio of the (meth) acrylate compound is 0 to 90% by weight (preferably 5 to 90% by weight) and the ratio of the above-mentioned urethane (meth)acrylate compound is 10 to 100% by weight (preferably 10 to 95% by weight) in total 100% by weight of the (meth)acrylate compound and urethane (meth)acrylate compound.

### Other Components

In the present invention, additives such as a polymerization initiator, an antistatic agent, a antiglare agent may be contained in the composition A or the composition B based on the necessity.

Examples usable as the polymerization initiator include acetophenones, benzophenones, Michiler benzoyl benzoate, α-aminoxime ester, tetramethylthiuram monosulfide, thioxanthones, and the like. Further, based on the necessity, a photosensitizer and a photo polymerization promoter may be added. As the photosensitizer and photo polymerization promoter, conventionally known agents may be used and examples include benzoin compounds such as benzoin, benzoin methyl ether, benzoin ethyl ether, benzoin isopropyl ether, α-methylbenzoin, α-phenylbenzoin, and the like; anthraquinone type compound such as anthraquinone and methyl anthraquinone; benzyl; diacetyl; phenyl ketone compounds such as acetophenone, benzophenone, and the like; sulfide compounds such as diphenyl disulfide, tetramethylthiurum sulfide, and the like; α-chloromethylnaphthalene; anthracene; halogenated hydrocarbons such as hexachlorobutadiene, pentachlorobutadiene, and the like; and thioxanthone, n-butylamine, triethylamine, tri-n-butylphosphine, and the like.

Specifically, for acetophenone type photo polymerization initiator, a benzophenone or thioxanthone photosensitizer is preferably used.

Examples of the antistatic agent include a quaternary ammonium salt, a pyridinium salt, various cationic compounds having a cationic group such as a primary, a secondary, and a tertiary amino group; anionic compounds having an anionic group such as a sulfonate group, a sulfate group, a phosphate group and a phosphonate group; ampholytic compounds such as amino acid and aminosulfate; nonionic compounds such as amino alcohol, glycerin and polyethylene glycol; organic metal compounds such as alkoxide tin or titanium; and metal chelate compounds such as an acetylacetonate salt of the organic metal compound; and further include compounds formed by polymerizing the compounds described above. Further, polymerizable compounds such as monomer or oligomer which has a tertiary amino group, a quaternary ammonium group or a metal chelate moiety and is polymerizable with ionizing radiation, and organic metal compounds like a coupling agent having a functional group polymerizable with ionizing radiation can also be used as an antistatic agent.

Further, conductive fine particles are also usable as an antistatic agent. Specific examples of the conductive fine particles may include metal oxide fine particles. Examples of metal oxides may include ZnO (refractive index 1.90 or less, hereinafter, the numeral value in the parentheses shows the refractive index), CeO₂ (1.95), Sb₂O₃ (1.71). SnO₂ (1.997), indium tin oxide often referred to as ITO (1.95), In₂O₃ (2.00), Al₂O₃ (1.63), antimony-doped tin oxide (abbreviation: ATO, 2.0), and aluminum-doped zinc oxide (abbreviation: AZO, 2.0).

The fine particle preferably has the average particle diameter of 5 μm or less preferably, more preferably 1 μm or less.

Further, as an antistatic agent, conductive polymers are usable. The materials are not particularly limited and examples of them may include at least one selected from the group consisting of aliphatic conjugated compounds such as polyacetylene, polyacene, and polyazulene; aromatic conjugated compounds such as polyphenylene; heterocyclic conjugated compounds such as polypyrrole, polythiophene, and polyisothianaphthene; hetero atom-containing conjugated compounds such as polyaniline, and polythienylenevinylene; mixed type conjugated compounds such as poly(phenylenevinylene), multi-chain type conjugated compounds such as conjugated compounds having multi-conjugated chains in molecules; derivatives of these conductive polymers; and conductive composite bodies, which are graft- or block-copolymers of these conjugated polymer chains with saturated polymers. In particular, it is preferably used an organic antistatic agent such as polythiophene, polyaniline, polypyrrole, and the like. Use of the organic type antistatic agent makes it possible to exhibit excellent antistatic property and simultaneously increase the total luminance transmittance and decrease the haze value of the optical layered body. In order to improve the conductivity and antistatic property, it is also possible to add an anion such as an organic sulfonic acid, iron chloride, and the like as a dopant (electron donor). In consideration of the dopant addition effect, polythiophene is preferably since it provides high transparency and antistatic property. As the polythiophene, oligothiophene can be also preferably used. The derivatives are not particularly limited and examples include alkyl-substituted compounds of polyphenylacetylene and polydiacetylene.

Various kinds of fine particles may be used as the antiglare agent. The shape of the fine particles may be truly spherical or elliptical and preferably truly spherical. The fine particles may include inorganic type and organic type particles. The fine particles preferably exhibit antiglare property and are transparent. Specific examples of the fine particles include silica beads in the case of an inorganic type, and plastic beads in the case of an organic type. Specific examples of plastic beads include polystyrene beads (refractive index; 1.60), melamine beads (refractive index; 1.57), acryl beads (refractive index; 1.49 to 1.535), acryl-styrene beads (refractive index; 1.54 to 1.58), benzoguamanine-formaldehyde condensate beads (1.66), benzoguanamine-melamine-formaldehyde condensate beads (1.52 to 1.66), melamine-formaldehyde condensate beads (1.66), polycarbonate beads, polyethylene beads, and the like. The above-mentioned plastic beads are preferable to have hydrophobic groups in the surfaces and styrene beads can be exemplified. Silica beads may include spherical silica and nonspherical silica. Additionally, organic and inorganic composite, silica-acrylic composite compound beads (refractive index of 1.52) are also used. Two or more of them may be used in combination.

In this case, a precipitation preventing agent may be used preferably in combination. It is because addition of the precipitation preventing agent suppresses precipitation of resin beads and evenly disperses them in a solvent. Specific examples of the precipitation preventing agent are silica beads with an average particle diameter of 0.5 μm or smaller and preferably 0.1 to 0.25 μm.

### Other Layers

As the basic layer configuration of the present invention, at least the hard coat layer A and the hard coat layer B may be formed on the light transmitting substrate. For example, the hard coat layer A is formed adjacently on the light transmitting substrate and the hard coat layer B is formed adjacently on the hard coat layer A to form a three-layer structure. In this case, to an extent that the light transmittance of the layered body of the present invention is not deteriorated, if necessary, one or more other layers (antistatic layer, antiglare layer, low refractive index layer, antifouling layer, adhesive layer, and other hard coat layers) can be suitably formed 1) between the hard coat layer A and the hard coat layer B; 2) on the hard coat layer B; and 3) under the hard coat layer A. These layers may be those for conventionally known layered body for antireflection.

### (Antistatic Layer)

The antistatic layer may be formed from a composition containing an antistatic agent and resin. In this case, a solvent may be also used. Examples to be used as the antistatic agent and solvent may be those described in the paragraph of the hard coat layer. The thickness of the antistatic layer is not particularly limited; however it is preferably set at 30 nm to 1 μm.

Examples usable as the resin include thermoplastic resins, thermosetting resins, ionizing radiation-curable resins, and ionizing radiation-curable compounds (including organic reactive silicon compounds). Among them, thermosetting resins, ionizing radiation-curable resins, and ionizing radiation-curable compounds are preferable. In particular, ionizing radiation-curable resins and/or ionizing radiation-curable compounds are even more preferable.

The ionizing radiation-curable compounds may be used in form of ionizing radiation-curable compositions containing these compounds. Examples usable as the ionizing radiation-curable compounds may be at least one of monomers, oligomers, and prepolymers having polymerizable unsaturated bonds or epoxy groups in molecules. The ionizing radiation beam means electromagnetic wave or charged particle beam having energy quantum for polymerizing or crosslinking the molecules and usually ultraviolet rays or electron beam may be used.

Examples of the prepolymers or oligomers in the ionizing radiation-curable composition include unsaturated polyesters of unsaturated dicarboxylic acids and polyhydric alcohols; methacrylates such as polyester methacrylate, polyether methacrylate, polyol methacrylate, melamine methacrylate, and the like; acrylates such as polyester acrylate, epoxy acrylate, urethane acrylate, polyether acrylate, polyol acrylate, melamine acrylate, and the like; and also cation polymerizable epoxy compounds. One, or two or more of them may be used.

Examples of the monomers in the ionizing radiation-curable composition may be at least one compound selected from styrene type monomers such as styrene and α-methylstyrene; acrylic acid esters such as methyl acrylate, 2-ethylhexyl acrylate, methoxyethyl acrylate, butoxyethyl acrylate, butyl acrylate, methoxybutyl acrylate, and phenyl acrylate; methacrylic acid esters such as methyl methacrylate, ethyl methacrylate, propyl methacrylate, methoxyethyl methacrylate, ethoxymethyl methacrylate, phenyl methacrylate, and lauryl methacrylate; unsaturated group-substituted aminoalcohol esters such as 2-(N,N-diethylamino)ethyl acrylate, 2-(N,N-dimethylamino)ethyl acrylate, 2-(N,N-dibenzylamino)methyl acrylate, and 2-(N,N-diethylamino)propyl acrylate; unsaturated carboxylic acid amides such as acrylamide and methacrylamide; diacrylate such as ethylene glycol diacrylate, propylene glycol diacrylate, neopentyl glycol diacrylate, 1,6-hexanediol diacrylate, and triethylene glycol diacrylate; polyfunctional compounds such as dipropylene glycol diacrylate, ethylene glycol diacrylate, propylene glycol dimethacrylate, diethylene glycol and dimethacrylate; and polythiol compounds having two or more thiol groups (e.g. trimethylolpropane trithioglycolate, trimethylolpropane trithiopropylate, and petaerythritol tetrathioglycolate).

One or more of the above-mentioned compounds are generally used in form of a mixture according to necessity as the monomers for the ionizing radiation-curable composition; however, it is preferable to contain 5% by weight or more of prepolymers or oligomers of the monomers and 95% by weight or less of the monomers and/or polythiols to give good coatability to the ionizing radiation-curable composition.

In the case the antistatic layer is required to have flexibility, it is desirable to lessen the monomer amount or use of acrylate monomers having one or 2 functional groups. Further, in the case where the antistatic layer is required to have wear resistance, heat resistance, and solvent resistance, it is preferable to use acrylate monomers having 3 or higher functional groups. Herein, examples of those having one functional group include 2-hydroxy acrylate, 2-hexyl acrylate, phenoxyethyl acrylate, and the like. Examples of those having two functional groups include ethylene glycol diacrylate, 1,6-hexanediol diacrylate, and the like. Examples of those having three or higher functional groups include trimethylolpropane triacrylate, pentaerythritol triacrylate, pentaerythritol tetraacrylate, dipentaerythritol hexaacrylate, and the like.

To adjust the physical properties of such as flexibility and surface hardness of the antistatic layer, resins which are not cured by radiating ionizing radiation beam may be added to the ionizing radiation-curable composition based on the necessity. Examples of the resins are one or more of thermoplastic resin such as polyurethane resins, cellulose resins, polyvinyl butyral resins, polyester resins, acrylic resins, poly(vinyl chloride) resins, poly(vinyl acetate) resins, and the like. Among them, at least one of polyurethane resins, cellulose resins, and polyvinyl butyral resins is preferable from the viewpoint of the improvement of flexibility. In the case curing of the ionizing radiation-curable composition is carried out by ultraviolet irradiation, a photo polymerization initiator or a polymerization promoter may be added. As the photo polymerization initiator in the case of resins having radical polymerizable unsaturated groups, acetophenones, benzophenones, thioxanthones, benzoin, benzoin methyl ethers may be used alone or two or more of them in combination. In the case of resins having cationic polymerizable functional group, as the photo polymerization initiator, usable examples are one or more of aromatic diazoniums, aromatic sulfoniums, aromatic iodoniums, metallocene compounds, benzoinsulfonic acid esters. The addition amount of the photo polymerization initiator can be suitably set in accordance with the types of the photo polymerization initiators; however, it may be set about 0.1 to 10 parts by weight with respect to 100 parts by weight of the ionizing radiation-curable composition.

If necessary, a reactive organic silicon compound may be used in combination for the ionizing radiation-curable composition. For example, compounds having a general formula RmSi (OR′) n (wherein R and R′ may be the same or different from each other and each denote an alkyl group having 1 to 10 carbon atoms; m and n each denote an integer while satisfying the relation of m+n=4).

Specific examples include at least one of tetramethoxylsilane, tetraethoxysilane, tetra-iso-propoxysilane, tetra-n-propoxysilane, tetra-n-butoxysilane, tetra-sec-butoxysilane, tetra-tert-butoxysilane, tetrapentaethoxysilane, tetrapenta-iso-propxysilane, tetrapenta-n-propxysilane, tetrapenta-n-butoxysilane, tetrapenta-sec-butoxysilane, tetrapenta-tert-butoxysilane, methyltriethoxysilane, methyltripropoxysilane, methyltributoxysilane, dimethyldimethoxysilane, dimethyldiethoxysilane, dimethylethoxysilane, dimethylmethoxysilane, dimethylpropoxysilane, dimethylbutoxysilane, methyldimethoxysilane, methyldiethoxysilane, hexyltrimethoxysilane, and the like.

In this case, as an organic silicon compound usable for the ionizing radiation-curable composition, a silane coupling agent may be used in combination based on the necessity. Examples for the silane coupling agent include γ-(2-aminoethyl)amonopropyltrimethoxysilane, γ-(2-aminoethyl)amonopropylmethyldimethoxysilane, β-(3,4-epoxycyclohexyl)ethyltrimethoxysilane, γ-aminopropyltriethoxysilane, γ-methacryloxypropylmethoxysilane, N-β-(N-vinylbenzylaminoethyl)-γ-aminopropylmethoxysilane hydrochloride, γ-glycidoxypropyltrimethoxysilane, aminosilane, methylmethoxysilane, vinyltriacetoxysilane, γ-mercaptopropyltrimethoxysilane, γ-chloropropyltrimethoxysilane, hexamethyldisilazane, vinyltris (β-methoxyethoxy)silane, octadecyldimethyl [3-(trimethoxysilyl)propyl]ammonium chloride, methyltrichlorosilane, dimethyldichlorosilane, and the like.

### (Antiglare Layer)

The antiglare layer may be formed, for example, between the transparent substrate and either the hard coat layer or a low refractive index layer (described later). The antiglare layer may be formed from a resin composition containing a resin and an antiglare agent.

As the resin, those described in the hard coat layer may be properly selected and used.

As the antiglare agent, various fine particles can be used. The average particle diameter of the fine particles is not particularly limited; however it is generally about 0.01 to 20 pm. The shape of the fine particles may be truly spherical or elliptical and preferably truly spherical. The fine particles may include inorganic and organic particles.

The fine particles exhibit antiglare property and preferably transparent. Specific examples of the fine particles include, in the case of an inorganic type, silica beads and in the case of an organic type, plastic beads. Specific examples of plastic beads are styrene beads (refractive index; 1.60), melamine beads (refractive index; 1.57), acryl beads (refractive index; 1.49 to 1.535), acryl-styrene beads (refractive index; 1.54 to 1.58), benzoguamanine-formaldehyde condensate beads (refractive index; 1.66), benzoguanamine-melamine-formaldehyde condensate beads (refractive index; 1.52 to 1.66), melamine-formaldehyde condensate beads (refractive index; 1.66), polycarbonate beads, polyethylene beads, and the like.

The plastic beads preferably have hydrophobic groups on the surfaces and styrene beads can be exemplified. Silica beads may be spherical silica and nonspherical silica. Additionally, silica-acrylic composite compound beads as organic-inorganic composites (refractive index 1.52) are also usable. Two or more of them may be used in combination.

The fine particles are preferably those which satisfy all of the following numeral expressions:

30≦Sm≦600,

0.05≦Rz≦1.60,

0.1≦θa≦2.5,

0.3≦R≦20:

wherein R (μm) denotes the average particle diameter; Rz (μm) denotes ten-point average roughness of the surface unevenness of the antiglare layer; Sm (μm) denotes the average interval of the unevenness of the antiglare layer; and θa denotes the average slanting angle β of the uneven parts.

Sm (μm)means the average interval of the unevenness of the antiglare layer; θa (degree) means the average slanting angle of the uneven parts; and (Rz) means ten-point average roughness of the surface unevenness of the antiglare layer and their definitions are described in instruction manual (revised on Jul. 20, 1995) of the surface roughness measurement apparatus: SE-3400 produced by Kosaka Laboratory Ltd.

The unit of θa is angle degree and in the case where Δa denotes the horizontal to vertical ratio of the inclination, Δa=tan θa=(total of differences of the minimum parts and maximum parts of respective projections and recessions (equivalent to the height of the respective projections)/standardized length). The standardized length is equal to the cut-off value λc of the roughness curve measured by measurement apparatus SE-3400, which is the actually probed evaluation length.

Further, in another preferable embodiment of the present invention, the antiglare layer is preferable to satisfy Δn=|n1−n2|<0.1 in the case where the refractive indexes of the fine particles and the resin composition are defined as n1 and n2, respectively, and the haze value of the inside of the antiglare layer is 55% or lower.

The addition amount of the fine particles, although it depends on the kind and desired antiglare property of the fine particles, may be generally 2 to 30 parts by weight and preferably 10 to 25 parts by weight with respect to 100 parts by weight of the resin composition.

At the time of preparing a composition for antiglare layers, a precipitation preventing agent may be added. Addition of the precipitation preventing agent suppresses precipitation of resin beads and evenly disperses them in a solvent. Specifically, as the precipitation preventing agent, beads such as silica beads can be used. The average particle diameter of the beads is not generally 0.5 μm or smaller and preferably 0.1 to 0.25 μm.

The film thickness of the antiglare layer (during curing) is, in general, preferably about 0.1 to 100 μm and particularly preferably about 0.8 to 10 μm. If the film thickness is not within the range, the function as the antiglare layer cannot be exhibited sufficiently.

### (Low Refractive Index Layer)

The low refractive index layer is a layer having a function of lowering the reflectivity when outside light (e.g. fluorescent lamp and natural light) is reflected on the surface of the optical layered body.

The low refractive index layer has a lower refractive index than that of the antiglare layer in the case it is formed on the surface of the antiglare layer. In a preferable embodiment of the invention, the refractive index of the antiglare layer is 1.5 or higher and the refractive index of the low refractive index layer is less than 1.5 and preferably 1.45 or lower.

The low refractive index layer preferably include a thin film containing one of 1) a material containing silica or magnesium fluoride, 2) a fluorine material, which is a low refractive index resin, 3) a fluorine material containing silica or magnesium fluoride, and 4) silica or magnesium fluoride.

The fluorine material means polymerizable compounds containing at least fluorine atom in the molecules and their polymers. The polymerizable compounds are not particularly limited and preferable examples include those having curing reactive groups such as functional groups (ionizing radiation-curable groups) curable by ionizing radiation and polar groups (thermosetting polar groups) curable by heat. Compounds having these reactive groups in combination are also usable.

As a polymerizable compound having an ionizing radiation-curable group containing a fluorine atom, a fluorine-containing monomer having an ethylenically unsaturated bond can be widely used.

More Specific examples include fluoro-olefins (e.g. fluoroethylene, vinylidene fluoride, tetrafluoroethylene, hexafluoropropylene, perfluorobutadiene, perfluoro-2,2-dimethyl-1,3-dioxol, and the like). Examples of polymerizable compounds having a (meth)acryloyloxy group include fluorine-containing (meth)acrylate compounds such as 2,2,2-trifluoroethyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluorooctyl)ethyl (meth)acrylate, 2-(perfluorodecyl)ethyl (meth)acrylate, α-trifluoromethyl methacrylate, and α-trifluoroethylmethacrylate; and fluorine-containing polyfunctional (meth)acrylic acid ester compounds containing fluoroalkyl groups, fluorocycloalkyl groups, or fluoroalkylene groups having at least 3 fluorine atoms and 1 to 14 carbon atoms and at least two (meth) acryloyloxy groups.

Examples of polymerizable compounds having thermosetting polar groups containing a fluorine atom include 4-fluoroethylene-perfluoroalkyl vinyl ether copolymers; fluoroethylene-hydrocarbon vinyl ether copolymers; and fluorine-modified products of epoxy, polyurethane, cellulose, phenol, and polyimide resins.

Preferable examples of the thermosetting polar groups are hydrogen bond forming groups such as hydroxyl, carboxyl, amino group, epoxy group and the like. They are excellent not only in adhesion to a coating film but also in affinity with inorganic ultrafine particles of such as silica.

Examples of polymerizable compounds having both ionizing radiation-curing group and thermosetting polar group include partially or completely fluorinated alkyl, alkenyl, aryl esters of acrylic or methacrylic acid; completely or partially fluorinated vinyl ethers; completely or partially fluorinated vinyl esters; completely or partially fluorinated vinyl ketones; and the like.

As polymers of polymerizable compounds containing a fluorine atom, polymers of monomers or monomer mixtures containing at least one kind of fluorine-containing (meth) acrylate compounds of the polymerizable compounds having ionizing radiation-curing groups; copolymers of at least one kind of the fluorine-containing (meth) acrylate compounds with fluorine atom-free (meth)acrylate compounds in the molecule such as methyl (meth)acrylate, ethyl (meth)acrylate, propyl (meth)acrylate, butyl (meth)acrylate, and 2-ethylhexyl (meth)acrylate; homopolymers or copolymers of fluorine-containing monomers such as fluoroethylene, vinylidene fluoride, trifluoroethylene, chlorotrifluoroethylene, 3,3,3-trifluoropropylene, 1,1,2-trichloro-3,3,3-trifluoropropylene, and hexafluoropropylene. Silicone-containing fluorovinylidene copolymers obtained by introducing silicone components into these copolymers are also usable.

Silicone-containing fluorovinylidene copolymers obtained by introducing silicone components into these copolymers are also usable. Examples of silicone components include (poly)dimethylsiloxane, (poly)diethylsiloxane, (poly)diphenylsiloxane, (poly)methylphenylsiloxane, alkyl-modified (poly)dimethylsiloxane, azo group-containing (poly)dimethylsiloxane, dimethylsilicone, phenylmethylsilicone, alkyl/aralkyl-modified silicone, fluorosilicone, polyether-modified silicone, fatty acid ester-modified silicone, methylhydrosilicone, silanol group-containing silicone, alkoxy group-containing silicone, phenol group-containing silicone, methacryl-modified silicone, acryl-modified silicone, amino-modified silicone, carboxylic acid-modified silicone, carbinol-modified silicone, epoxy-modified silicone, mercapto-modified silicone, fluorine-modified silicone, polyether-modified silicone and the like. In particular, those having dimethylsiloxane structure are preferable.

Further, compounds obtained by reaction of fluorine-containing compounds having at least one isocyanato group in each molecule with compounds having at least one functional group such as an amino group, a hydroxyl group, and a carboxyl group in each molecule which is reactive on an isocyanato group; compounds obtained by reaction of fluorine-containing polyols such as fluorine-containing polyether polyols, fluorine-containing alkyl polyols, fluorine-containing polyester polyols, and fluorine-containing ε-caprolactone-modified polyols with isocyanato group-containing compounds; and the like, are usable as fluorine materials.

In the case of forming the low refractive index layer, for example, a composition containing raw material components (composition for low refractive index layers) maybe used. More specifically, a solution or a dispersion obtained by dissolving or dispersing raw material components (resin, and the like) and based on the necessity, additives (e.g. “fine particles having voids” described below, a polymerization initiator, an antistatic agent, an antiglare agent, and the like) in a solvent is used as the composition for forming a low refractive index layer and a coating film is formed using the composition and the coating film is cured to form the low refractive index layer. The additives such as the polymerization initiator, the antiglare agent, and the like are not particularly limited and publicly known ones can be exemplified.

As the solvent, examples thereof include those exemplified for the composition for hard coat layers, and preferable examples are methyl isobutyl ketone, cyclohexanone, isopropyl alcohol (IPA), n-butanol, tert-butanol, diethyl ketone, PGME, and the like.

A method for preparing the above-mentioned composition is a method for evenly mixing components, and the publicly known methods may be employed. Mixing may be carried out using, for example, the publicly known apparatus described in the hard coat layer formation.

A method for forming the coating film may be carried out in accordance with the publicly known method. For example, various methods described in the hard coat layer formation may be employed.

A method for curing the obtained coating film may be properly selected in accordance with contents of the compositions. For example, in the case of ultraviolet curing type, ultraviolet rays may be radiated to the coating film to cure the film.

In the low refractive index layer, “fine particles having voids” are preferably used as a low refractive index agent. The “fine particles having voids” can reduce the refractive index of the antiglare layer while maintaining layer strength of the layer. In the present invention, the term “fine particles having voids” means particles having a structure in which the inside of the particle is filled with gas and/or a porous structure including gas is formed, and a characteristic that the refractive index is decreased in inverse proportion to a gas occupancy in the fine particle compared with the particle's own refractive index. In the present invention, a fine particle, in which a nano porous structure can be formed inside the coat and/or in at least a part of the coat surface, based on the configuration, the structure and the agglomeration condition of the fine particles and the state of dispersed particles in a coat, is included. The refractive index of the low refractive index layer using this particle can be adjusted to a refractive index of 1.30 to 1.45.

Examples of inorganic fine particles having voids include silica fine particles prepared by a method described in Japanese Kokai Publication 2001-233611. Silica fine particles prepared by a production method described in Japanese Kokai Publication Hei-7-133105, Japanese Kokai Publication 2002-79616, and Japanese Kokai Publication 2006-106714, may be used. Since the silica fine particle having voids is easily produced and has high particle's own hardness, layer strength thereof is enhanced and it becomes possible to adjust the refractive index to a range of about 1.20 to 1.45 when the particles are mixed with the binder resin to form the low refractive index layer. Particularly, specific preferable examples of organic fine particles having voids include hollow polymer particles prepared by use of a technology disclosed in Japanese Kokai Publication 2002-80503.

Examples of the particle, in which a nano porous structure can be formed inside the coat and/or in at least a part of the coat surface, include a slow-release agent produced for the purpose of increasing a specific surface area, in which various chemical substances is adsorbed on a column for filling and a porous portion of the surface, porous particles used for fixing a catalyst, and dispersed substances or agglomerated substances of hollow particles for the purpose of incorporating in a heat insulating material or a low dielectric material in addition to the silica particles. Specifically, it is possible to select and use the particles within the range of the preferable particle diameter of the present invention from agglomerated substances of porous silica particles of commercially available Nipsil or Nipgel (both trade name) produced by Nihon silica kogyo corporation and colloidal silica UP series (trade name), having a structure in which silica particles are linked with one another in a chain form, produced by Nissan Chemical Industries, Ltd.

An average particle diameter of the “fine particles having voids” is 5 nm or more and 300 nm or less, and preferably, a lower limit is 8 nm and an upper limit is 100 nm, more preferably, a lower limit is 10 nm and an upper limit is 80 nm. It becomes possible to impart excellent transparency to the antiglare layer when the average particle diameter of the particles falls within this range. In addition, the average particle diameter is measured by a dynamic light-scattering method. An amount of the “fine particles having voids” is usually about 0.1 to 500 parts by weight with respect to 100 parts by weight of resins in the low refractive index layer, and preferably about 10 to 200 parts by weight.

In forming the low refractive index layer, it is preferable to set the viscosity of the composition for low refractive index layers in a range of 0.5 to 5 cps (25° C.) where a preferable application property is attained, and preferably 0.7 to 3 cps (25° C.). An excellent antireflection film of visible light can be realized, a uniform thin film can be formed without producing irregularity of application, and a low refractive index layer having particularly excellent adhesion to the substrate can be formed.

A method for curing the resin may be methods as the same as mentioned in an antiglare layer. In the case where heating means is employed for the curing treatment, it is preferable to add a thermal polymerization initiator for starting polymerization of the polymerizable compounds by generating radicals by heating.

A film thickness (nm) d_{A} of the low refractive index layer preferably satisfies the following equation (I):

d_{A}=mλ/(4n_{A}) (I),

wherein n_{A} represents a refractive index of the low refractive index layer, m represents a positive odd, and preferably 1, λ is a wavelength, and preferably values from 480 nm to 580 nm.

Further, in the present invention, it is preferable from the viewpoint of reducing a reflection factor that the low refractive index layer satisfies the following equation (II):

120<n_{A} d_{A}<145 (II)

### (Antifouling Layer)

The antifouling layer is a layer for preventing deposition of stains (fingerprints, water-based or oil-based inks, pencils, and the like) on the outermost layer of the optical layered body or making it easy to wipe out the stains even in the case of deposition. In a preferable embodiment of the present invention, a antifouling layer may be formed for preventing the stains on the outermost surface of the low refractive index layer and it is particularly preferable to form the layer on one face or both opposed faces of the light transmitting substrate bearing the low refractive index layer. Formation of the antifouling layer improves the antifouling property and the scratching resistance to the optical layered body (an antireflection layered body). In the case where there is no low refractive index layer, the antifouling layer may be formed for preventing the outermost surface stains.

The antifouling layer can be formed generally by using a composition containing an agent for the antifouling layer and a resin. Specific examples of the agent for the antifouling layer include fluoro compounds and/or silicon compounds which have poor compatibility with compositions containing the ionizing radiation-curable resins having fluorine atoms in each molecule and which are difficult to be added to the low refractive index layer; and fluoro compounds and/or silicon compounds which have compatibility with compositions containing the ionizing radiation-curable resins having fluorine atoms in each molecule and fine particles. Publicly known or commercialized compounds can be used.

The antifouling layer may be formed, for example, on the hard coat layer B. Particularly, it is desirable to form the antifouling layer in a manner that the antifouling layer forms the outermost surface. The antifouling layer can be substituted with, for example, the hard coat layer B by providing the antifouling property.

### Interface of Optical Layered Body

The optical layered body of the present invention is desirable to have substantially no interface. Herein, the mean of “(substantially) no interface existing” may include 1) although two layer faces are overlapped, actually no interface exists and 2) no interface exists in both faces in terms of refractive indexes.

Substantial determination standard of “(substantially) no interface existing” is judged as described later, for example. That is, a black tape is stuck to the rear face of the optical layered body and the optical layered body is observed with eyes from the top part under radiation of light of a three wave fluorescent lamp. In this case, if interference fringes are observed, it can be confirmed that an interface can be observed separately by observation of a cross-section with a laser microscope and therefore, it is determined to be a proof of the “interface existence”. On the other hand, if no interference fringe is extremely weakly observed or not, any interface can be observed to be extremely thin or not be observed and therefore, it is determined to be a proof of “(substantially) no interface existing”.

A laser microscope can read out reflected light from each interface and observe the cross section nondestructively. Therefore, cross section observation of multilayered materials having refractive index differences can be carried out, and if the existence of an interface is extremely scarcely observed or never, it substantially leads to the conclusion of absence of any interface. Accordingly, absence of the interface between the substrate and the hard coat layers can be judged.

Further, the optical layered body of the present invention preferably has substantially no interface. It is at least desirable that no interference fringe is observed with eyes.

In the optical layered body of the present invention, both hard coat layers A and B can satisfy prescribed hardness. In this case, the hard coat layer A desirably has a pencil hardness of 4 H or higher. The hard coat layer A desirably has a Vicker's hardness of 450 N/mm or higher. The hard coat layer B desirably has a pencil hardness of 4 H or higher. The hard coat layer B is desirable to have a Vicker's hardness of 550 N/mm or higher.

### EXAMPLES

Hereinafter, the invention will be described more in detail with reference to Examples and Comparative Examples; however, it is not intended that the invention be limited to the illustrated Examples.

### Production Example 1

As the composition for forming a hard coat layer, the following compositions A to I were prepared respectively.

### Composition A

Polyester acrylate (M9050, trifunctional, molecular weight 418, produced by Toagosei Co., Ltd.): 10 parts by weight

Polymerization initiator (IRGACURE 184, produced by Ciba Specialty Chemicals Inc.): 0.4 parts by weight

Methyl ethyl ketone (hereinafter, referred to as MEK): 10 parts by weight

### Composition B

Polyester acrylate (M9050, trifunctional, molecular weight 418, produced by Toagosei Co., Ltd.): 5 parts by weight

Urethane acrylate (DPHA40H, decafunctional, molecular weight about 7000, produced by Nippon Kayaku Co., Ltd.): 5 parts by weight

Polymerization initiator (IRGACURE 184, produced by Ciba Specialty Chemicals Inc.): 0.4 parts by weight

MEK: 10 parts by weight

### Composition C

Polyethylene glycol diacrylate (M240, bifunctional, molecular weight 302, produced by Toagosei Co., Ltd.): 2 parts by weight

Urethane acrylate (DPHA40H, decafunctional, molecular weight about 7000, produced by Nippon Kayaku Co., Ltd.): 6 parts by weight

Urethane acrylate (BS371, deca- or higher-functional, molecular weight about 40000, produced by Arakawa Chemical Industries Ltd.): 2 parts by weight

Polymerization initiator (IRGACURE 184, produced by Ciba Specialty Chemicals Inc.): 0.4 parts by weight

MEK: 10 parts by weight

### Composition D

Polyethylene glycol diacrylate (M240, bifunctional, molecular weight 302, produced by Toagosei Co., Ltd.): 10 parts by weight

Polymerization initiator (IRGACURE 184, produced by Ciba Specialty Chemicals Inc.): 0.4 parts by weight

MEK: 10 parts by weight

### Composition E

Urethane acrylate (Shikoh UV 3520-TL bifunctional, molecular weight about 14000, produced by Nippon Synth. Chem. Ind. Co., Ltd.): 10 parts by weight

Polymerization initiator (IRGACURE 184, produced by Ciba Specialty Chemicals Inc.): 0.4 parts by weight

MEK: 10 parts by weight

### Composition F

Urethane acrylate (Shikoh UV 1700B., decafunctional, molecular weight about 2000, produced by Nippon Synth. Chem. Ind. Co., Ltd.): 10 parts by weight

Polymerization initiator (IRGACURE 184, produced by Ciba Specialty Chemicals Inc.): 0.4 parts by weight

MEK: 10 parts by weight

### Composition G

Polyester acrylate (M9050, trifunctional, molecular weight 418, produced by Toagosei Co., Ltd.): 10 parts by weight

Polymerization initiator (IRGACURE 184, produced by Ciba Specialty Chemicals Inc.): 0.4 parts by weight

Toluene: 10 parts by weight

### Composition H

Dipentaerythritol hexaacrylate (DPHA, hexafunctional, molecular weight 524, produced by Nippon Kayaku Co., Ltd.): 2.5 parts by weight

Urethane acrylate (Shikoh UV 1700B, decafunctional, molecular weight about 2000, produced by Nippon Synth. Chem. Ind. Co., Ltd.): 2.5 parts by weight

Urethane acrylate (BS371, deca- or higher-functional, molecular weight about 40000, produced by Arakawa Chemical Industries Ltd.): 2.5 parts by weight

Polymerization initiator (IRGACURE 127, produced by Ciba Specialty Chemicals Inc.): 0.4 parts by weight

MEK: 10 parts by weight

### Composition I

Dipentaerythritol hexaacrylate (DPHA, hexafunctional, molecular weight 524, made by Nippon Kayaku Co., Ltd.): 2 parts by weight

Urethane acrylate (Shikoh UV 1700B, decafunctional, molecular weight about 2000, made by Nippon Synth. Chem. Ind. Co., Ltd.): 2 parts by weight

Urethane acrylate (BS371, deca- or higher-functional, molecular weight about 40000, made by Arakawa Chemical Industries Ltd.): 3 parts by weight

Surface-treated colloidal silica: 3 parts by weight

Polymerization initiator (IRGACURE 184, produced by Ciba Specialty Chemicals Inc.): 0.4 parts by weight

MEK: 10 parts by weight

### Production Example 2

As the composition for forming a hard coat layer, the following compositions a to e and composition a′ were prepared respectively.

### Composition a

Dipentaerythritol hexaacrylate (DPHA, hexafunctional, molecular weight about 547, produced by Nippon Kayaku Co., Ltd.): 5 parts by weight

Urethane acrylate (BS371, deca- or higher-functional, molecular weight about 40000, produced by Arakawa Chemical Industries Ltd.): 5 parts by weight

Polymerization initiator (IRGACURE 184, produced by Ciba Specialty Chemicals Inc.): 0.4 parts by weight

MEK: 10 parts by weight

### Composition b

Pentaerythritol triacrylate (PET 30, trifunctional, molecular weight about 298, produced by Nippon Kayaku Co., Ltd.): 5 parts by weight

Urethane acrylate (HDP, decafunctional, molecular weight about 4500, produced by Negami Chemical Industrial Co., Ltd.): 5 parts by weight

Polymerization initiator (IRGACURE 184, produced by Ciba Specialty Chemicals Inc.): 0.4 parts by weight

MEK: 10 parts by weight

### Composition c

Urethane acrylate (Shikoh UV 1700B, decafunctional, molecular weight about 2000, produced by Nippon Synth. Chem. Ind. Co., Ltd.): 10 parts by weight

Polymerization initiator (IRGACURE 184, produced by Ciba Specialty Chemicals Inc.): 0.4 parts by weight

### Composition d

Isocyanuric acid EO-modified diacrylate (M215, bifunctional, molecular weight 369, produced by Toagosei Co., Ltd.): 10 parts by weight

Polymerization initiator (IRGACURE 184, produced by Ciba Specialty Chemicals Inc.): 0.4 parts by weight

### Composition e

Dipentaerythritol hexaacrylate (DPHA, hexafunctional, molecular weight about 547, produced by Nippon Kayaku Co., Ltd.): 10 parts by weight

Polymerization initiator (IRGACURE 184, produced by Ciba Specialty Chemicals Inc.): 0.4 parts by weight

Composition a′

Dipentaerythritol hexaacrylate (DPHA, hexafunctional, molecular weight about 547, produced by Nippon Kayaku Co., Ltd.): 5 parts by weight

Urethane acrylate (BS371, deca- or higher-functional, molecular weight about 40000, produced by Arakawa Chemical Industries Ltd.): 5 parts by weight

Antifouling agent (UT3971, produced by Nippon Kayaku Co., Ltd.): 0.5 parts by weight

Polymerization initiator (IRGACURE 184, produced by Ciba Specialty Chemicals Inc.): 0.4 parts by weight

MEK: 10 parts by weight

### Example 1

A resin mixture of the composition A as the composition for forming the hard coat layer A, an underlayer, in a wet amount of 26 g/m² (dry weight 13 g/m²) was applied to one face of a cellulose triacetate film (thickness 80 μm) and dried at 70° C. for 60 seconds and irradiated with 50 mJ/cm² ultraviolet rays to form a hard coat layer A as an underlayer.

Further, a resin mixture of the composition a as the composition for forming the hard coat layer B, a top layer, in a wet amount of 26 g/m² (dry weight 13 g/m²) was applied to the hard coat layer A and dried at 70° C. for 60 seconds and irradiated with 200 mJ/cm² ultraviolet rays to form a hard coat layer B and thus a desired optical layered body was obtained.

### Examples 2 to 11

Respective optical layered bodes of Examples 2 to 11 were obtained in the same manner as Example 1, except that in the hard coat layer formation, the hard coat layers were formed using the compositions for forming the hard coat layer A as an underlayer and the compositions for forming the hard coat layer B as a top layer in combinations and application amounts respectively shown in Table 1.

### Comparative Examples 1 to 6

Respective optical layered bodes of Comparative Examples 1 to 6 were obtained in the same manner as Example 1, except that in the hard coat layer formation, the hard coat layers were formed using the compositions for forming the hard coat layer A as an underlayer and the compositions for forming the hard coat layer B as a top layer in combinations and application amounts respectively shown in Table 2.

### Experiment Example 1

The optical layered bodies obtained in respective Examples and Comparative Examples were evaluated according to the following evaluation standards. The results are shown in Table 1 and Table 2.

### (1) Test for Existence of Interference Fringes

A black tape was stuck to the opposed face to the hard coat layer of each optical layered body to prevent reflection by the rear face and the optical layered body was observed from the hard coat layer side with eyes and evaluation was carried out based on the following evaluation standard.

### Evaluation Standard

Evaluation good: no interference fringe was observed.

Evaluation poor: interference fringes were observed.

### (2) Pencil Hardness Test

Pencil hardness test: the hardness of pencil scratching test was carried out at 4.9 N load according to a pencil hardness test standardized in JIS K 5400 using a pencil for test (hardness 4 H) standardized in JIS S-6006 after each produced hard coat film (the optical layered body, hereinafter the same) was wet at 25° C. and 60% relative humidity for 2 hours.

### Evaluation Standard

Evaluation good: no scratch/measurement times 4/5, 5/5

Evaluation poor: no scratch/measurement times 0/5, 1/5, 2/5, 3/5

### (2) Curling Test

Each of produced hard coat films was cut in a size of width×length 10 cm×10 cm, and curling at four corners was observed at the time the cut film was set still on a flat plate at 20° C. and 60% relative humidity, and the average value was set as the curing height.

### Evaluation Standard

Evaluation good: 25 mm or lower

Evaluation poor: higher than 26 mm (x was marked for those which became cylindrical and measurement was thus impossible.)

### (4) Cracking Test

Each of produced hard coat films was cut in a size of 10 cm×5 cm and rolled around a cylindrical metal pipe with a diameter of 16 mm and then unrolled and the existence of cracks was observed with eyes.

### Evaluation Standard

Evaluation good: no crack observed.

Evaluation poor: cracks were observed.

TABLE 1

| Examples | | 1 | 2 | 3 | 4 | 5 | 6 | 7 | 8 | 9 | 10 | 11 |
|---|---|---|---|---|---|---|---|---|---|---|---|---|
| Under | Resin | A | A | B | B | A | C | A | A | A | H | I |
| layer | composition | | | | | | | | | | | |
| | Solvent | MEK | MEK | MEK | MEK | MEK | MEK | MEK | MEK | MEK | MEK | MEK |
| | Application | 13 | 13 | 13 | 13 | 13 | 13 | 4 | 16 | 13 | 13 | 13 |
| | amount (g/m²) | | | | | | | | | | | |
| Top | Resin | a | B | a | b | a | c | a | a | a′ | H | I |
| layer | composition | | | | | | | | | | | |
| | Solvent | MEK | MEK | MEK | MEK | Toluene | MEK | MEK | MEK | MEK | MEK | MEK |
| | Application | 13 | 13 | 13 | 13 | 13 | 13 | 16 | 4 | 13 | 13 | 13 |
| | amount (g/m²) | | | | | | | | | | | |

| | | | | | | | | | | | |
|---|---|---|---|---|---|---|---|---|---|---|---|
| Pencil hardness | good | good | good | good | good | good | good | good | good | good | good |
| Interference fringes | good | good | good | good | good | good | good | good | good | good | good |
| Cracking prevention | good | good | good | good | good | good | good | good | good | good | good |
| Curling | good | good | good | good | good | good | good | good | good | good | good |

TABLE 2

| Comparative Examples | | 1 | 2 | 3 | 4 | 5 | 6 |
|---|---|---|---|---|---|---|---|
| Under | Resin | D | E | A | B | F | G |
| layer | composition | | | | | | |
| | Solvent | MEK | MEK | MEK | MEK | MEK | Toluene |
| | Application | 13 | 13 | 13 | 13 | 20 | 13 |
| | amount (g/m²) | | | | | | |
| Top | Resin | a | A | d | e | none | a |
| layer | composition | | | | | | |
| | Solvent | MEK | MEK | MEK | MEK | none | MEK |
| | Application | 13 | 13 | 13 | 13 | 0 | 13 |
| | amount (g/m²) | | | | | | |

| | | | | | | |
|---|---|---|---|---|---|---|
| Pencil hardness | good | poor | poor | good | poor | good |
| Interference fringes | poor | poor | good | good | poor | poor |
| Cracking prevention | good | good | good | poor | good | good |
| Curling | good | good | good | poor | poor | good |

As is cleared from the results shown in Table 1 and Table 2, it is found that according to the invention, layered bodies excellent in hardness and cracking resistance and showing no interference fringes can be obtained.

### INDUSTRIAL APPLICABILITY

The invention provides an optical layered body which can efficiently suppress or prevent occurrence of interference fringes and exhibit high surface hardness. The optical layered body of the invention is preferably applicable to a cathode-ray tube (CRT) display device, a liquid crystal display (LCD), a plasma display (PDP), an electroluminescent display (ELD), a field emission display (FED), or the like.

1. An optical layered body comprising:
at least (1) a hard coat layer A adjacent to a light transmitting substrate and (2) a hard coat layer B, formed on the substrate,
wherein there is substantially no interface between the substrate and the hard coat layer A.

2. The optical layered body according to claim 1,
wherein the hard coat layer B is formed from a composition B containing a urethane (meth)acrylate compound having 6 or higher functional groups.

3. The optical layered body according to claim 2,
wherein the urethane (meth)acrylate compound has a weight average molecular weight of 1000 to 50000.

4. The optical layered body according to claim 1,
wherein the hard coat layer A is formed from a composition A containing a compound A having a weight average molecular weight of 200 or higher and 3 or higher functional groups.

5. The optical layered body according to claim 4,
wherein the compound A is at least one of a (meth)acrylate compound and a urethane (meth)acrylate compound.

6. The optical layered body according to claim 4,
wherein the composition A contains a solvent having penetrability or solubility for the substrate.

7. The optical layered body according to claim 1,
which has substantially no interference fringe.

8. The optical layered body according to claim 1,
wherein the hard coat layer A and the hard coat layer B have a pencil hardness of 4 H or higher.

9. The optical layered body according to claim 1,
wherein the hard coat layer A has a Vicker's hardness of 450 N/mm or higher and the hard coat layer B has a Vicker's hardness of 550 N/mm or higher.

10. The optical layered body according to claim 1, further comprising an antistatic layer, an antiglare layer, a low refractive index layer, an antifouling layer, or two or more of these layers 1) between the hard coat layer A and the hard coat layer B; 2) on the hard coat layer B; or 3) under the hard coat layer A.

11. The optical layered body according to claim 1,
which is used as an antireflection layered body.

12. A method for producing an optical layered body comprising the steps of:
(1) forming a hard coat layer A by applying a composition A to a light transmitting substrate;
(2) forming a hard coat layer B by applying a composition B to the hard coat layer A,
wherein the composition A contains a compound A having a weight average molecular weight of 200 or higher and 3 or higher functional groups and a solvent having penetrability and solubility for the light transmitting substrate, and
the composition B contains a urethane (meth)acrylate compound having 6 or higher functional groups.

13. The optical layered body according to claim 5,
wherein the composition A contains a solvent having penetrability or solubility for the substrate.

14. The optical layered body according to claim 2, which has substantially no interference fringe.

15. The optical layered body according to claim 3, which has substantially no interference fringe.

16. The optical layered body according to claim 4, which has substantially no interference fringe.

17. The optical layered body according to claim 5, which has substantially no interference fringe.

18. The optical layered body according to claim 6, which has substantially no interference fringe.

19. The optical layered body according to claim 2,
wherein the hard coat layer A and the hard coat layer B have a pencil hardness of 4 H or higher.

20. The optical layered body according to claim 3,
wherein the hard coat layer A and the hard coat layer B have a pencil hardness of 4 H or higher.
